(19) United States
(12) Patent Application Publication
(10) Pub. No.: US 2006/0190863 A1
(43) Pub. Date: Aug. 24, 2006

(54) Method for improving accuracy of MOSFET models used in circuit simulation integrated circuits

(76) Inventors: Valery Axelrad, Woodside, CA (US); Andrei Shibkov, San Jose, CA (US)

Correspondence Address: Valery Axelrad, 137 Chapman Rd., Woodside, CA, 94062, US

(21) Appl. No.: 11/347,885

(22) Filed: Feb. 6, 2006

Related U.S. Application Data
(60) Provisional application No. 60/651,695, filed on Feb. 9, 2005.

(51) Int. Cl. G06F 17/50

(52) U.S. Cl. 716/4

(57) ABSTRACT

Disclosed is a method of modeling submicron MOSFETs for the purpose of circuit simulation. This invention is capable of accurately predicting performance of a MOSFET with complex geometry closely approximating the actual geometry of a device manufactured as part of an integrated circuit. Actual device geometry is predicted using physical simulation to account for process-related pattern distortion. The method constructs a sub-circuit representation of a MOSFET that is equivalent to a regular MOSFET compact model when ideal device geometry is assumed, while providing substantially better accuracy when process-related geometry distortion is considered. Models created using the disclosed method are compatible with existing circuit simulators. The method may be readily implemented using SPICE or other circuit simulators in a design flow.

### CROSS-REFERENCE TO RELATED APPLICATIONS

This patent application is claiming the benefit of a prior filed provisional application Ser. No. 60/651,695, filed on Feb. 9, 2005, entitled “System and method for improving accuracy of MOSFET models used in circuit simulation of integrated circuits”.

### BACKGROUND OF THE INVENTION

1. Field of the Invention

The present invention relates generally to integrated circuit development, modeling and simulation and more specifically to improving accuracy of MOSFET models used in circuit simulation of integrated circuits.

2. Description of Related Art

An indispensable tool in the design of integrated circuits is the method of circuit simulation. The most familiar and commonly used circuit simulation tool is Berkeley SPICE and its commercial derivatives.

To run SPICE or other circuit simulation, the circuit designer provides a) a description of the circuit known as the netlist, b) chooses models for the various circuit elements and their parameter values, and c) specifies the desired analysis, which determines what kind of simulation will be performed in order to obtain the desired output, this set of SPICE commands is known as the input deck.

Active semiconductor devices such as MOSFETs are modeled using so-called compact models, analytic descriptions of device electrical behavior as a function of bias conditions as well as device geometry and doping. A number of compact MOSFET models have been proposed, the most popular models for submicron integrated circuit applications are currently the BSIM3 and newer BSIM4 model.

However, as MOSFET process technology moves deeper into the submicron region, the accuracy of circuit simulation using common circuit simulation tools such as SPICE in combination with standard compact device models such as BSIM3/4, greatly diminishes. The loss of accuracy occurs because the commonly used SPICE transistor models do not accurately capture 3-D effects, which become increasingly important in modern manufacturing processes. There are two primary reasons for the loss of MOSFET modeling accuracy:
1) Compact MOSFET models commonly use one channel length and one channel width parameter, implying a rectangular shape of the MOSFET viewed from the top. In general, the actual shape of the MOSFET is however substantially more complex and cannot be represented by one rectangle.
2) Compact models do not accurately account for edge effects related to the manufacturing process, post-manufacturing mechanical stress or other narrow width effects.

One common technique used to improve modeling accuracy is to replace elements in question with more complex sub-circuits comprising several elements and designed to better represent the behavior of the actual physical device. An example application of such technique to improve MOSFET modeling accuracy at high frequencies is described in U.S. Pat. No. 6,618,837.

In designing an equivalent sub-circuit to account for physical pattern distortion effects in a MOSFET it is important to consider practical issues such as simulation efficiency and compatibility with existing circuit simulators. Excessive complexity of the resulting sub-circuit would significantly increase simulation times and may create numerical problems with existing circuit simulators making it impossible to use them in practical simulations. Models incompatible with existing compact models and circuit simulators would require new parameter extraction techniques to be devised and adopted.

Therefore a new practical approach to MOSFET modeling is needed that can accurately describe both nominal and statistical behavior of submicron devices, while relying as much as possible on the existing MOSFET modeling infrastructure and maintaining compatibility with existing circuit simulators. Another important requirement for the MOSFET model is to be generally applicable to simulation of different types of circuits and a wide range of device geometries.

### SUMMARY OF THE INVENTION

The present invention overcomes the limitations of prior art by providing a method for modeling submicron MOSFETs, capable of accurately predicting performance of a MOSFET with complex geometry closely approximating the actual geometry of a device manufactured as part of an integrated circuit. At the same time it provides a sub-circuit representation of a MOSFET that is equivalent to a regular MOSFET circuit model when ideal rectangular device geometry is assumed. Advantageously, the models created using the disclosed method are compatible with standard circuit simulators. The method may be readily implemented as part of a SPICE or other circuit simulation in a design flow. Such simulation may be employed to analyze circuits comprising analog and digital designs, and to study both nominal and statistical circuit performance as well as interaction between circuit and physical design and manufacturing process. This method readily lends itself to be implemented as a part of Design For Manufacturability (DFM) flow.

The present invention consists of a method for MOSFET modeling comprising:
1) partitioning a complex MOSFET geometry into a plurality of geometrically smaller MOSFETs;
2) creating a sub-circuit comprising the new MOSFETs and possibly additional circuit elements;
3) generating a new set of parameter values for MOSFET models in such a way that new sub-circuit representation of the original MOSFET is electrically equivalent to the original MOSFET model when ideal rectangular geometry is assumed, while accurately capturing effects of non-ideal shape of real as-manufactured MOSFETs.

The present invention provides flexibility in the choice of simulation tools and simulation flow such that any SPICE-compatible or other circuit simulator can be used for subsequent simulations using MOSFET sub-circuit models created by present invention. Additionally there is no limitation as to which device-models can be used by the circuit simulator since the disclosed method makes no explicit assumption about the specific type of the MOSFET models used for each sub-circuit element. Further, the original structure and hierarchy of the SPICE model may also be maintained, allowing drop-in integration of the present invention in a design flow.

### BRIEF DESCRIPTION OF THE DRAWINGS

FIG. 1 Flow chart of the method of the invention.

FIG. 2 Layout example showing as-drawn MOSFETs with ideal rectangular geometry.

FIG. 3 Layout example showing realistic MOSFET geometry as obtained from lithography simulation may be observed in manufactured ICs.

FIG. 4 Slicing methodology to capture three-dimensional transistor geometry effects by a quasi-three-dimensional multi-transistor sub-circuit.

FIG. 5 Original MOSFET and its sub-circuit representation.

FIG. 6 I-V characteristics of MOSFET predicted by conventional device model and one created using the method of this invention.

### DETAILED DESCRIPTION OF THE PREFERRED EMBODIMENT

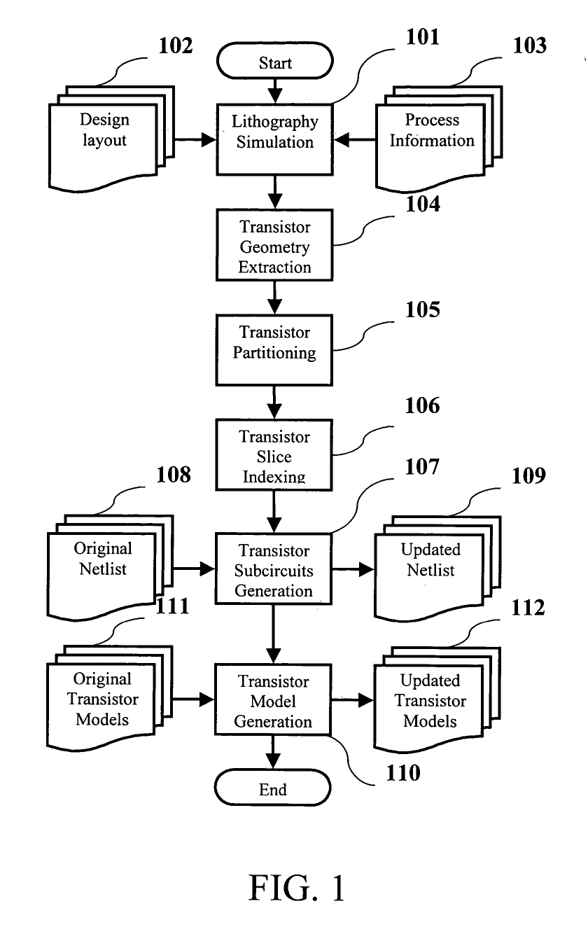

FIG. 1 depicts flow chart of a method of the invention. The flow begins at step 101 with lithography simulation. Lithography simulation uses input data in the form of the design layout 102 and lithographic process information 103 to predict final shapes of layout elements, which define transistor geometry.

Design layout 102 can be presented in any standard format such as GDS-II.

Process information 103 is a complete set of parameters characterizing the photolithography process which may include light source parameters such as wavelength and partial coherence, stepper parameters such as numerical aperture, aberrations and misalignment, as well as photoresist development and etch process parameters. Exact number of parameters characterizing lithographic process varies depending on the specifics of the lithographic process itself and models used to simulate the process.

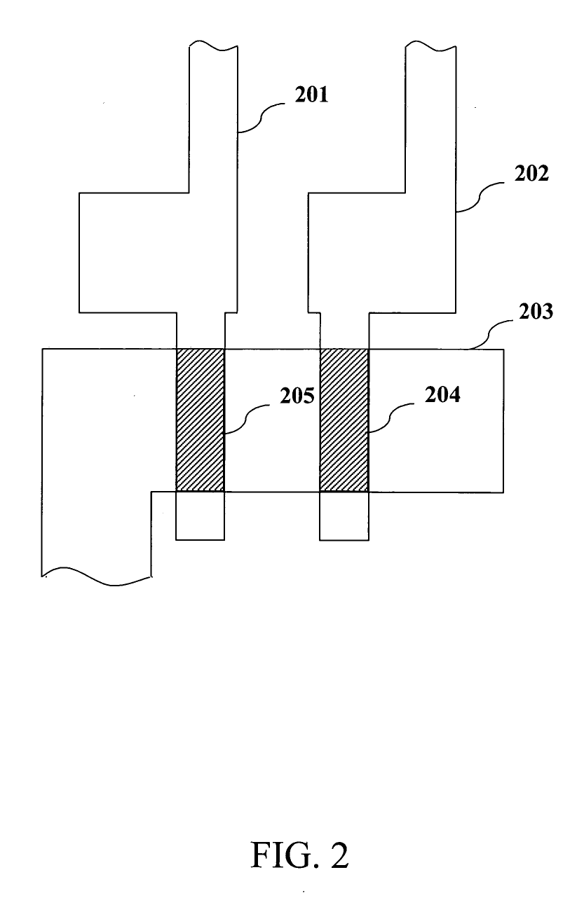

FIG. 2 presents a part of a typical integrated circuit layout in which polysilicon layer polygons 201 and 202 in combination with active layer polygon 203 define rectangular transistor gates 204 and 205 which are shaded in the FIG. 2. This is an example of the input 102 to the lithography simulation step 101.

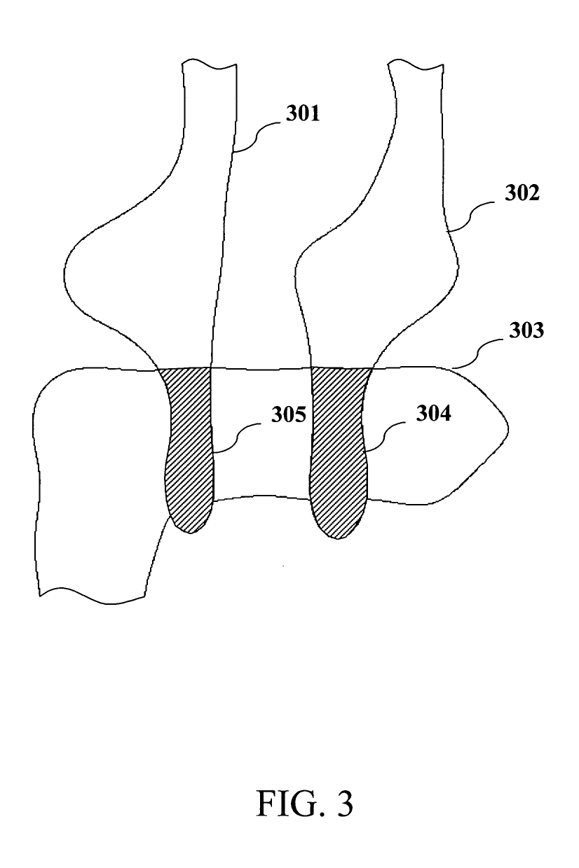

FIG. 3 depicts results of lithography simulation performed for the layout in FIG. 2 under typical process conditions. Polygons 201, 202 and 203 are transformed by the lithographic process into complex shapes 301, 302 and 303 respectively. This is an example of the lithography simulation output in step 101.

Step 104 extracts transistor geometry. Transistors are identified using original layout 102 (FIG. 2) and results of step 101 (FIG. 3). Shaded shapes 304 and 305 in FIG. 3 represent the as-manufactured nonrectangular transistor shapes extracted in step 104, corresponding to the original rectangular transistor gates 204 and 205 shown in FIG. 2.

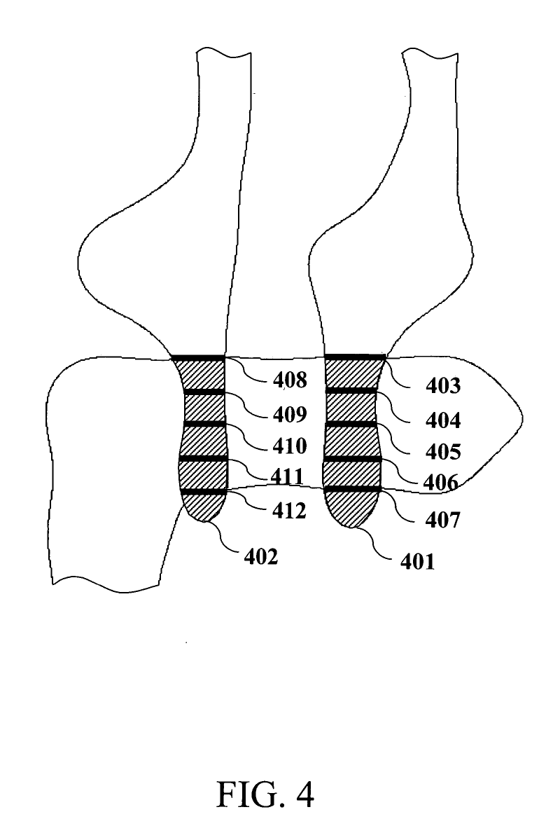

Step 105 performs transistor partitioning. In this step cutlines are placed across the nonrectangular transistor gates to measure transistor gate linear dimension. FIG. 4 illustrates the partitioning process. In this figure cutlines 403 through 412 are placed at several locations to measure local length of nonrectangular gates 401 and 402. The desired sampling accuracy, transistor gate width and parameters of the lithographic process determine the number of cutlines per transistor gate and spacing between cutlines.

Step 106 performs indexing of transistor slices. There are 3 parameters (indexes) associated with each cutline: length L, width W and distance from the transistor edge Z. Parameters L and Z are directly measured while parameter W is calculated based on the distance between edge cutlines such as 403 and 407, the total number of cutlines and cutline location.

For example, if uniform partitioning is used in step 105 and Wtot is the distance between cutlines 403 and 407, then the value of parameter W associated with cutlines 404, 405 and 406 would be Wtot/4 and the value of parameter W associated with cutlines 403 and 407 would be Wtot/8. If non-uniform partitioning is used in step 105, W parameter values assigned to transistor slices change accordingly.

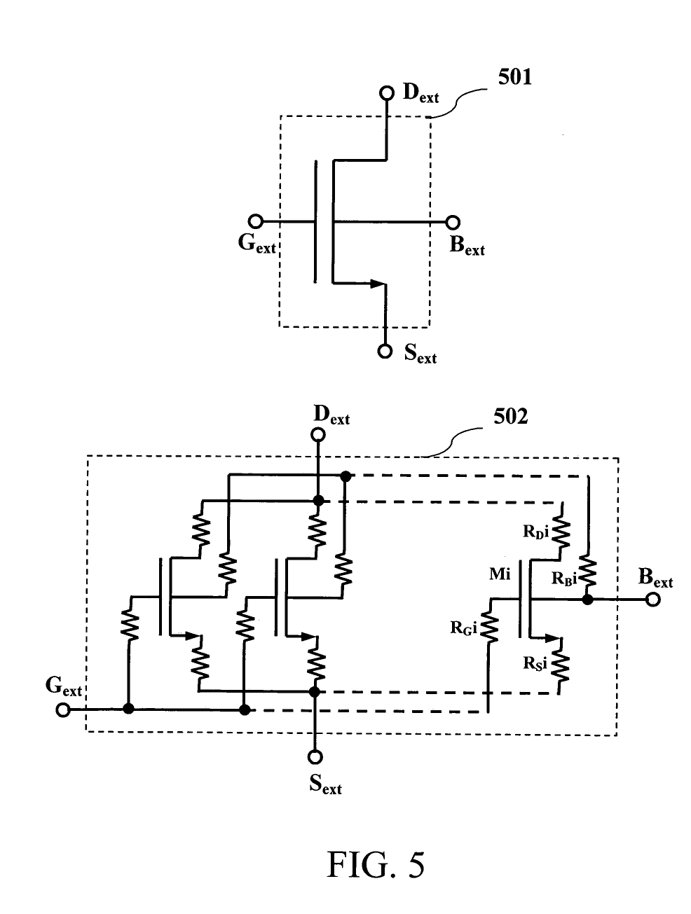

Step 107 generates a sub-circuit for each transistor based on the number of cutlines created and cutline parameters calculated in step 106. FIG. 5 illustrates the process of sub-circuit generation. A single MOSFET 501 is replaced by a sub-circuit 502 consisting of several MOSFETs Mi and optionally, one or more resistors R_{Gi}, R_{Di}, R_{Si} and R_{Bi} which can be used to increase accuracy of sub-circuit representation of the actual MOSFET. Each device Mi in the sub-circuit is assigned L, W and Z parameters calculated in step 106. Table 1 shows a part of original (input) netlist 108 and Table 2 shows a section of corresponding updated (output) netlist 109 created by the method of this invention.

TABLE 1
EXAMPLE INPUT NETLIST

mn1 n1 inp_a gnd gnd NE l=0.09e−6 w=0.24e−6 x=0.385 y=0.5
mn2 buff inp_b n1 gnd NE l=0.09e−6 w=0.24e−6 x=0.65 y=0.5
mn3 n2 inp_c buff gnd NE l=0.09e−6 w=0.24e−6 x=1.37 y=0.5
mn4 gnd inp_d n2 gnd NE l=0.09e−6 w=0.24e−6 x=1.64 y=0.5
mn5 out buff gnd gnd NE l=0.09e−6 w=0.24e−6 x=2.22 y=0.5

TABLE 2
EXAMPLE OUTPUT NETLIST
—

mnls0 n1 inp_a gnd gnd NE_0d24x0d03 L=0.0835047e-6 W=0.03e-6
mnls1 n1 inp_a gnd gnd NE_0d24x0d06 L=0.0938711e-6 W=0.06e-6
mnls2 n1 inp_a gnd gnd NE_0d24x0d06 L=0.0863481e-6 W=0.06e-6
mnls3 n1 inp_a gnd gnd NE_0d24x0d06 L=0.079154e-6 W=0.06e-6
mnls4 n1 inp_a gnd gnd NE_0d24x0d03 L=0.0832352e-6 W=0.03e-6

—

Each transistor in the input netlist is replaced by a sub-circuit in the output netlist, in particular MOSFET mn1 in the original netlist is replaced by a sub-circuit consisting of 5 MOSFET devices mn1s0 through mn1s4 as shown in Table 2.

Step 110 generates updated transistor models 112 required by the updated netlist 109. Values of the parameters of the original transistor models 111 are transformed based on the L, W and Z values calculated for each transistor in step 106 and saved in the updated netlist 109. The new set of parameter values for MOSFET models is generated in such a way that new sub-circuit representation 502 of the original MOSFET 501 is electrically equivalent to the original MOSFET model when ideal geometry is assumed. Table 3 and Table 4 illustrate this process. Table 3 shows original BSIM3 model parameters and Table 4 shows updated set of model parameters generated by the method of this invention.

TABLE 1
EXAMPLE INPUT MODEL

.MODEL NE NMOS
+ LEVEL = 49
+dvt0=0 k3=0
+tnom=26.85 tox=3e-009 xj=8.3333e-009 npeak=5.295e+017
+vbm=−5 mobMod=1 capMod=−5 VTH0=0.32819
+K1=0.9196 K2=−0.0037332 U0=0.060166 UA=−4.5177e-011 UB=1e−020
+UC=−5.8075e-011 VSAT=10896 PCLM=6.2401 Lint=2.0868e-11 RDSW=101.22
+CJ=1.391e-017 CGS0=3.294e-016 n1x=1.7037610E-07

TABLE 4
EXAMPLE OUTPUT MODEL

.MODEL NE_0d5x0d053996 NMOS
+uc = −5.808081E−011 nlx = 1.703931E−007 xj = 8.334133E−009
+vth0 = 0.32819 tox = 3.0003E−009
+capmod = −5 k1 = 0.9196 cj = 1.391139E−017 k2 = −0.003733573
vbm = −5
+vsat = 10896 k3 = 0 tnom = 26.85 lint = 2.087009E−011
+npeak = 5.295e+017 rdsw = 101.22 level = 49 pclm = 6.2401
+cgs0 = 3.294329E−016 u0 = 0.06017202 ua = −4.518152E−011 dvt0 = 0
+mobmod = 1 ub = 1.0001E−020 wr = 1 b0 = 0 b1 = 0 wwn = 1 dwb = 0
+wlc = 0 dwc = 0 cjsw = 5E−010 k3b = 0 lwn = 1 dwg = 0 wint = 0
wl = 0
+jsw = 0 dvt1w = 5300000 w0 = 2.5E−006

Optionally, to account for narrow width effects, parameters of the new output MOSFET models corresponding to different cutlines may be adjusted based on the value of parameter Z (distance from transistor edge). Required data describing MOSFET parameters on transistor width, may be obtained from either experimental or simulation-based narrow width characterization.

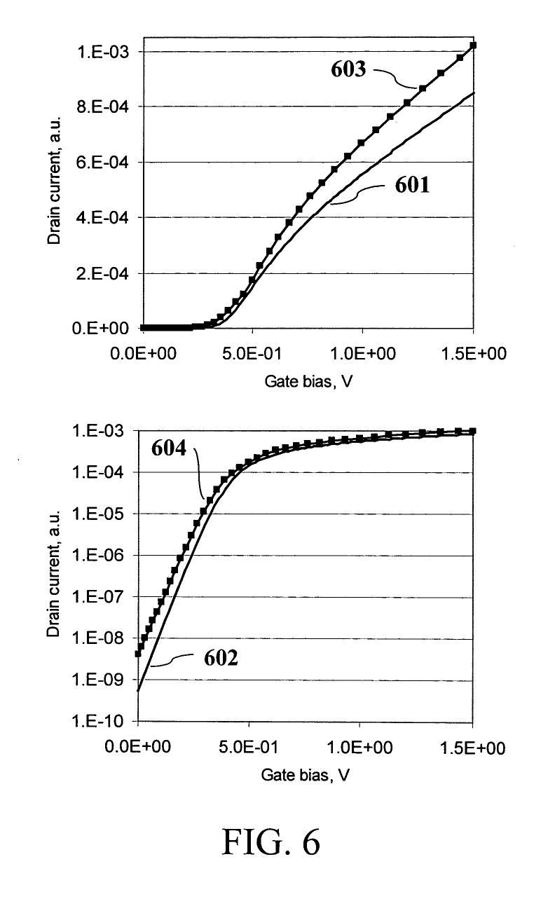

FIG. 6 illustrates the effect of taking non-rectangular transistor shape into account. Curves 601 and 602 correspond to the I-V characteristics (in linear and logarithmic scale respectively) of a MOSFET device with idealized rectangular shape, assumed by standard circuit models commonly used for circuit simulation. Curves 603 and 604 correspond to the transistor model created using the method of this invention and capturing complex non-rectangular device geometry, which clearly results in a significant change in device I-V characteristics. This change in device I-V characteristics may significantly affect various aspects of circuit performance of both digital and analog circuits.

As described, the present invention provides a convenient method that allows for accurate prediction of performance of a MOSFET with complex geometry closely approximating the actual geometry of a device manufactured as part of an integrated circuit. Models created using the disclosed method are compatible with existing circuit simulators providing great flexibility in the simulation tools that may be employed.

What is claimed is:

1. A method for improving accuracy of MOSFET models used in circuit simulation of integrated circuits, said method comprising:
a) receiving the original design, corresponding netlists used in circuit simulation, compact transistor models required by the said netlists and polygonal description of as manufactured patterns of the original design elements
b) partitioning the geometric elements of as-manufactured patterns corresponding to MOSFET devices in which cutlines are placed across the nonrectangular transistor gates in the source-drain direction to divide transistors into narrower slices. Measuring linear dimensions of these transistor slices.
c) indexing of the transistor slices which calculates and assigns width (W), length (L), and distance from edge (Z) parameters to each transistor slice
d) replacing each transistor in the original netlist with a sub-circuit consisting of one or more transistors corresponding to the transistor slices created by partitioning “b”
e) generating a new set of model parameters for each transistor in the subcircuit created in “d”, using the original transistor models received in “a” and values of L and W parameters calculated in “c”

2. The method of claim 1 in which as-manufactured polygon patterns received in “a” are extracted from experimental data such as SEM or TEM.

3. The method of claim 1 in which lithography simulation is used to predict as manufactured polygon shapes received in “a”.

4. The method of claim 1 in which narrow-width effect characterization data is used in “e” to make new model parameters dependent on value of parameter Z calculated in “c”.

5. The method of claim 1 in which original layout is used to identify MOSFET devices in step “b”.

6. The method of claim 1 in which an additional step is added generating a single transistor model, which represents the best possible fit to characteristics of subcircuit created in step “d” using models generated in step “e”. This model is then used in the original netlist, in place of the original transistor model thus reducing the amount of extra data created by the method simplifying subsequent circuit simulation.
